(19) United States
(12) Patent Application Publication
(10) Pub. No.: US 2018/0224517 A1
(43) Pub. Date: Aug. 9, 2018

(54) TRACKING SYSTEM AND METHOD

(71) Applicant: FIND-ME TECHNOLOGIES PTY LTD, Queensland (AU)

(72) Inventors: David Craig INGERSON, Edens Landing (AU); Bruce JEFFERS, Ormeau (AU)

(21) Appl. No.: 15/750,873

(22) PCT Filed: Aug. 15, 2016
(86) PCT No.: PCT/AU2016/050754

§ 371 Date: Feb. 7, 2018

(30) Foreign Application Priority Data
Aug. 17, 2015 (AU) 2015903311

(51) Int. Cl. G01S 5/00; G01S 19/12; G01S 19/48

(52) U.S. Cl. CPC G01S 5/0027; G01S 19/48; G01S 19/12

(57) ABSTRACT

A tracking system for locating an individual, the tracking system including a processing system that remotely monitors a wearable tracking device worn by the individual, wherein the wearable tracking device includes a housing, a user interface device, including at least one of, a display mounted in a face of the housing, a speaker, a microphone, a location sensor that senses a location of the wearable tracking device and a wearable tracking device processor that communicates with the processing system via a communications network. The wearable tracking device processor performs tracking and performs user interface control by receiving a user interface control indication provided by the processing system and controlling the user interface in accordance with the user interface control indication.

### BACKGROUND OF THE INVENTION

The present invention relates to a system and method for tracking an individual using a wearable tracking device, such as a watch, broach or the like.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Caring for elderly people, particularly those suffering from dementia can be difficult, as they are often unaware that they have the condition, and can often become disorientated and confused, leading to them becoming lost. When this occurs, it is often necessary to launch a wide scale search, which is a drain on resources, such as the emergency services, and in some cases has lead to death in the event that the individual is not found. Accordingly, there is a need to provide a system for tracking individuals that is straightforward enough to allow this to be used for individuals suffering from dementia.

WO2011/035390 describes a tracking system for tracking the location of an individual, the tracking system including a tracking device worn by the subject in use, the tracking device including a processor for determining a tracking device location and transferring location information indicative of the tracking device location to a base station via a communications network, the base station being for generating a location indication indicative of the tracking device location using the location information and providing the location indication to at least one user via a user end station and a communications network.

US2005/0250440 describes systems, methods and applications utilizing the convergence of any combination of the following three technologies: wireless positioning or localization technology, wireless communications technology and sensor technology. In particular, certain embodiments of the present invention relate to a remote device that includes a sensor for determining or measuring a desired parameter, a receiver for receiving position data from the Global Positioning System (GPS) satellite system, a processor for determining whether or not alert conditions are present and a wireless transceiver for transmitting the measured parameter data and the position data to a central station, such as an application service provider (ASP). The ASP, in turn, may communicate the measured data, position data and notification of any alerts to an end user via an alert device. The present invention also relates to various applications and systems utilizing the capabilities of such a device.

### SUMMARY OF THE PRESENT INVENTION

In one broad form the present invention seeks to provide a tracking system for locating an individual, the tracking system including a processing system that remotely monitors a wearable tracking device worn by the individual, wherein the wearable tracking device includes:
a) a housing;
b) a user interface device, including at least one of:
   i) a display mounted in a face of the housing;
   ii) a speaker; and,
   iii) a microphone;
c) a location sensor that senses a location of the wearable tracking device; and,
d) a wearable tracking device processor that communicates with the processing system via a communications network, wherein the wearable tracking device processor:
   i) performs tracking by:
      (1) determining a wearable tracking device location in accordance with signals from the location sensor;
      (2) providing an indication of the wearable tracking device location to the processing system, the processing system being adapted to at least one of:
         (a) store an indication of the wearable tracking device location in a store; and,
         (b) selectively generate notifications based on the wearable tracking device location; and,
   ii) performs user interface control by:
      (1) receiving a user interface control indication provided by the processing system; and,
      (2) controlling the user interface in accordance with the user interface control indication.

In one broad form the present invention seeks to provide a tracking system for locating an individual, the tracking system including a processing system that remotely monitors a wearable tracking device worn by the individual, wherein the wearable tracking device includes:
a) a housing;
b) a strap coupled to the housing to retain the wearable tracking device on an arm of the individual;
c) a locking system that locks the strap in a securing location to thereby secure the wearable tracking device to an arm of the wearer;
d) a display mounted in a face of the housing;
e) a speaker;
f) a microphone;
g) a location sensor that senses a location of the wearable tracking device; and,
h) a wearable tracking device processor that communicates with the processing system via a communications network, wherein the wearable tracking device processor performs tracking by:
   i) determining a wearable tracking device location in accordance with signals from the location sensor; and,
   ii) providing an indication of the wearable tracking device location to the processing system, the processing system being adapted to at least one of:
      (1) store an indication of the wearable tracking device location in a store; and,
      (2) selectively generate notifications based on the wearable tracking device location.

In one broad form the present invention seeks to provide a tracking system for locating an individual, the tracking system including a processing system that remotely monitors a wearable tracking device worn by the individual, wherein the wearable tracking device includes:
a) a housing;
b) a display mounted in a face of the housing;
c) a location sensor that senses a location of the wearable tracking device; and,
d) a wearable tracking device processor that communicates with the processing system via a communications network, wherein the wearable tracking device processor:
   i) determines a wearable tracking device location in accordance with signals from the location sensor; and,
   ii) provides an indication of the wearable tracking device location to the processing system, the processing system being adapted to at least one of:
      (1) store an indication of the wearable tracking device location in a store; and,
      (2) selectively generate notifications based on the wearable tracking device location and wherein the processing system:
         (a) monitors signals from the wearable tracking device;
         (b) determines an elapsed time from a last received signal;
         (c) compares the elapsed time to a threshold; and,
         (d) selectively generates an alert depending on the results of the comparison.

In one broad form the present invention seeks to provide a tracking system for locating an individual, the tracking system including a processing system that remotely monitors a wearable tracking device worn by the individual, wherein the wearable tracking device includes:
a) a housing;
b) a display mounted in a face of the housing;
c) a location sensor that senses a location of the wearable tracking device;
d) a movement sensor that senses movement of the wearable tracking device; and,
e) a wearable tracking device processor that communicates with the processing system via a communications network, wherein the wearable tracking device processor:
   i) detects movement of the wearable tracking device in accordance with signals from the movement sensor;
   ii) determines if the movement corresponds to a view raise action using signals from the movement sensor; and,
   iii) at least one of:
      (1) activates the display in response to a positive determination; and,
      (2) selectively determines a wearable tracking device location in response to a negative determination.

Typically the wearable tracking device strap includes a breakable coupling that connects the strap to the body.

Typically the strap includes:
a) first strap portion coupled to the housing at a first end and having a plurality of apertures along a length of the strap portion; and,
b) a second strap portion coupled to the housing at a second end and having a mounting proximate a second end, wherein in use, a fastener is inserted through one of the apertures and threadingly engages the mounting to thereby secure the first and second strap portions.

Typically the fastener includes a head having a tapered profile and a socket that in use receives a key allowing the fastener to be rotated thereby threadingly engaging the mounting.

Typically the wearable tracking device processor:
a) determines an operating mode; and,
b) selectively generates the alert depending on the operating mode.

Typically the wearable tracking device includes an input and wherein the processor determines the operating mode in accordance with input commands received via the input.

Typically the wearable tracking device processor doesn't generate the alert if the wearable tracking device is in a charging mode.

Typically the wearable tracking device includes:
a) a battery for supplying power to at least the processor and display; and,
b) a coil mounted to a surface of the body, the coil being electrically coupled to the battery to allow inductive charging of the battery.

Typically the processing system generates the control signal at least in part based on at least one of:
a) an operating mode; and,
b) a wearable tracking device location.

Typically the processing system determines the operating mode in accordance with at least one of:
a) input commands received via an input provided on the wearable tracking device; and,
b) a wearable tracking device location.

Typically the user interface control includes at least one of:
a) adjusting a volume of at least one of the microphone and the speaker; and,
b) selectively activating a touch screen function of the display.

Typically the processing system determines the threshold at least in part based on:
a) an operating mode; and,
b) a wearable tracking device location.

Typically the processing system determines the operating mode in accordance with at least one of:
a) input commands received via an input provided on the wearable tracking device; and,
b) a wearable tracking device location.

Typically the processing system:
a) determines a last known wearable tracking device location from the wearable tracking device location stored in the store; and,
b) generates the alert in accordance with the last known wearable tracking device location.

Typically the processor:
a) determines if the movement corresponds to a view raise action using signals from the movement sensor; and,
b) at least one of:
   i) activates the display in response to a positive determination; and,
   ii) selectively determines a wearable tracking device location in response to a negative determination.

Typically the wearable tracking device includes a communications system that communicates with communications networks and wherein the processor determines the location using a local proximity to a communications network.

Typically the wearable tracking device includes an absolute location sensor and the processor determines the location using the absolute location sensor.

Typically the wearable tracking device includes:
a) a first location sensor; and,
b) a second location sensor, and wherein the wearable tracking device processor:
   i) determines first and second locations using signals from the first and second location sensors;
   ii) compares the first and second locations; and,
   iii) determines the wearable tracking device location in accordance with the results of the comparison.

Typically the wearable tracking device processor determines the wearable tracking device location using a last known wearable tracking device location and movement of the wearable tracking device determined using signals from the movement sensor.

Typically the wearable tracking device includes a fall sensor, the fall sensor being separate to the movement sensor.

It will be appreciated that the broad forms of the invention, and their respective features can be used in conjunction and/or independently, and reference to separate broad forms in not intended to be limiting.

### BRIEF DESCRIPTION OF THE DRAWINGS

An example of the present invention will now be described with reference to the accompanying drawings, in which:—

FIG. 1 is a schematic diagram of an example of a tracking system for locating an individual;

FIG. 2 is a schematic diagram showing further details of an example of a tracking system for locating an individual;

FIG. 3 is a flow chart of an example of a process for locating an individual;

FIG. 4A is a schematic plan view of an example of a strap in an open position;

FIG. 4B is a schematic cross-sectional view along the line A-A′ of FIG. 4A;

FIG. 4C is a schematic plan view of the strap of FIG. 4A in a closed position;

FIG. 4D is a schematic cross-sectional view along the line B-B′ of FIG. 4C;

FIG. 5 is a flow chart of an example of a process for determining a wearable tracking device worn status;

FIG. 6 is a schematic diagram of an example of a charging system;

FIGS. 7A and 7B are a flow chart of an example of a process for determining a wearable tracking device worn status to generate an alert upon removal of the wearable tracking device;

FIG. 8 is a flow chart of an example of a process for remotely controlling a user interface;

FIG. 9 is a flow chart of an example of a process for automated presence detection;

FIGS. 10A and 10B are a flow chart of a specific example of a process for presence detection;

FIG. 11 is a flow chart of an example of a process for battery saving; and,

FIG. 12 is a flow chart of a specific example of a process for battery saving.

### DETAILED DESCRIPTION OF THE PREFERRED EMBODIMENTS

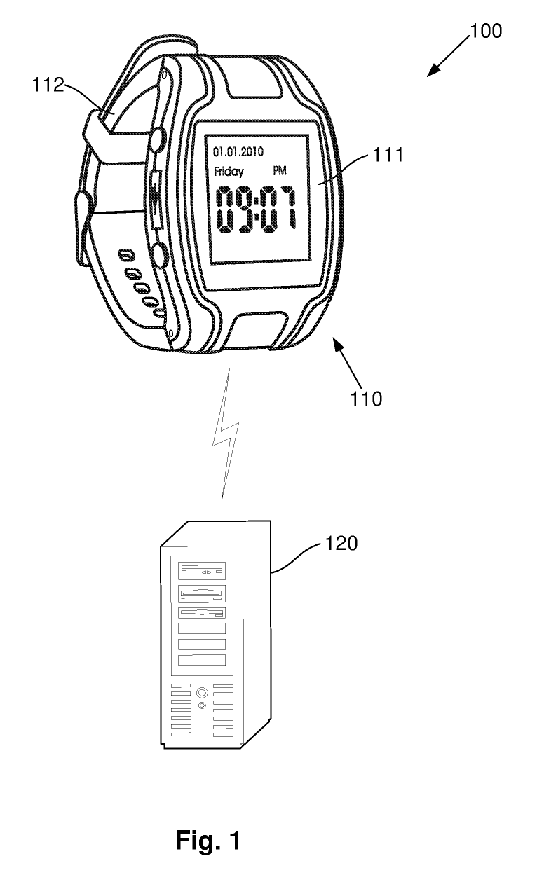

An example of a tracking system for locating an individual will now be described with reference to FIG. 1.

In this example, the tracking system 100 includes a wearable tracking device 110 that in use is worn by the individual being tracked. The wearable tracking device typically includes a housing 111 and a strap 112 coupled to the housing for retaining the wearable tracking device on an arm of the individual being tracked (hereinafter referred to as the wearer). In this example, the wearable tracking device is functioning as a watch, but it will be appreciated that in some examples this is not essential, and the strap can alternatively be removed, with the wearable tracking device acting as a pendant, broach or the like.

The housing 111 typically contains electronics required in order to determine a location, with an indication of this being provided wirelessly to a remote processing system 120, such as a client device, computer system, remote server, or the like.

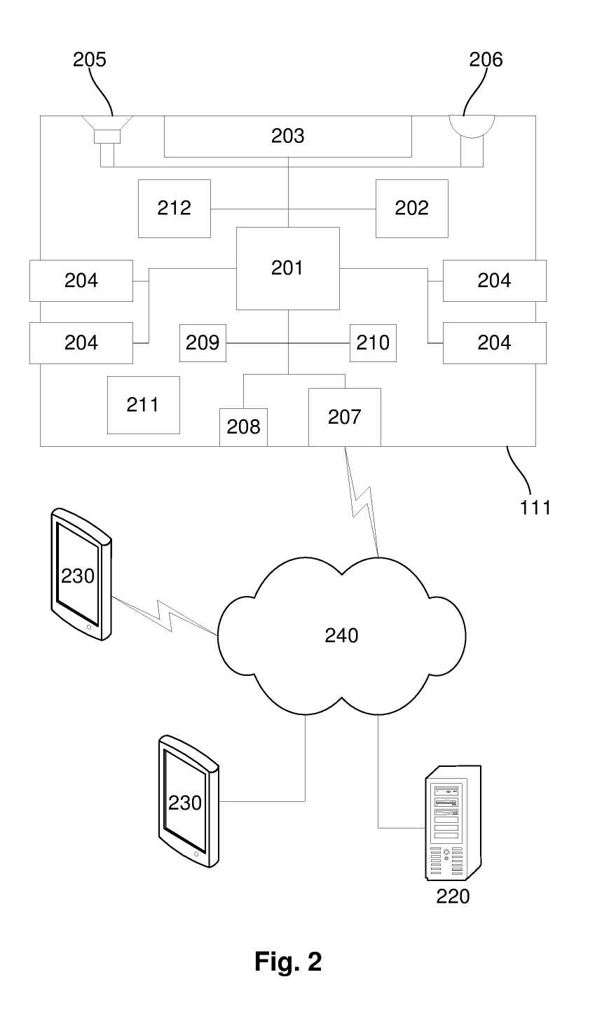

Further details of an example of a tracking system will now be described with reference to FIG. 2.

In this example, the system includes the wearable tracking device 110, in communication with one or more of a processing system 220 and client devices 230, via a communications network 240.

The wearable tracking device 110 includes the housing 111 containing a processor 201, a memory 202, a display 203 such an LCD display, or the like and one or more input buttons 204. The wearable tracking device typically also includes a speaker 205 and microphone 206, and a communications interface 207 for allowing wireless communication with the communications network 240. The housing 111 can also contain one or more sensors, including a light sensor 208, movement sensor 209 and position sensor 210, as well as a power supply 211, such as a battery, for powering the electrical components within the housing 111.

The watch can also include a separate fall sensor 212, which is adapted to perform fall detection. The fall sensor 212 could be in the form of an accelerometer or the like, and whilst this could be of a similar form to the movement sensor, in one example the movement and fall sensors are separate, allowing dedicated monitoring of each to be performed for respective purposes.

In use, the microprocessor 201 operates to execute instructions stored in the memory 202, allowing signals from the sensors 208, 209, 210 and input commands supplied via the input buttons 204 to be interpreted, allowing information to be presented via the display 203 and for communicating with processing system 220 and/or client devices 230.

In use, the processing system 220 operates to receive information from the wearable tracking device 110, including an indication of a current location, as well as other information, such as voice communications from the wearer. The processing system 220 can also be adapted to provide information to the wearable tracking device, for example allowing aspects of wearable tracking device operation to be controlled remotely by the processing system 220.

As well as being able to communicate with the wearable tracking device 110, the processing system 220 is also able to communicate with one or more client devices 230, via the communications network 240, allowing alerts, status information or other notifications to be provided thereto. The processing system 220 may also be configured to receive commands from the client devices, allowing these to be routed to the wearable tracking device 110, allowing this to be controlled remotely by the client devices 230. The processing system 220 can also be coupled to one or more databases 221, allowing data, such as information received from wearable tracking devices 110 to be stored therein and retrieved as required, as well as allowing user and wearer profiles to be maintained, as will become apparent from the following description.

Whilst the processing system 220 is shown as a single entity, it will be appreciated that the processing system 220 can be distributed over a number of geographically separate locations, for example by using multiple processing systems 220 and/or databases 221 that are provided as part of a cloud based environment. However, the above described arrangement is not essential and other suitable configurations could be used.

It will be appreciated from this that the client devices 230 must be capable of communicating via the communications network(s) 240, displaying content to users and receiving user input commands. Whilst the client devices 230 may be of any suitable form, these are typically a computer system, or a mobile communications device such as a smart phone, tablet, phablet, smart wearable tracking device, or the like.

The communications network 240 can include one or more communications networks, such as the Internet, local area networks (LANs), cellular networks, phone networks or the like, and the use of the communications network is for the purpose of example only. In practice the processing system 220 and client devices 230 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

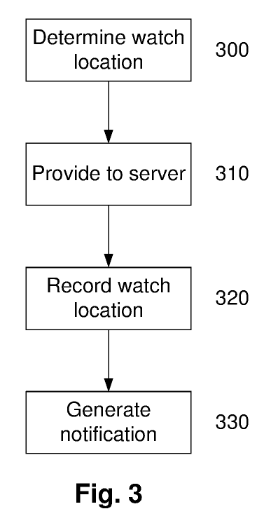

The general process for tracking an individual will now be described with reference to FIG. 3.

In this example, at step 300 a wearable tracking device location is determined. In particular, the wearable tracking device processor 201 determines the wearable tracking device location in accordance with signals from one or more of the movement and/or position sensor 209, 210. As will be described in more detail below, the movement sensors 209 can include inertial sensors capable of tracking movement of the wearable tracking device from a known prior location, whilst the position sensors 210 could include absolute position sensors, such as a GPS sensor, or the like, allowing the wearable tracking device location to be determined in relation to external reference locations.

At step 310 the wearable tracking device location is provided to the processing system 220 which then records the wearable tracking device location in a store such as the database 221, allowing this to be subsequently retrieved. In this regard, the processing system 220 typically maintains a record associated with each wearable tracking device, that includes a profile regarding the wearer, and any particular requirements associated with the wearer, such as medical conditions and associated treatments and/or needs, as well as information regarding next of kin, carers, or the like, and their respective contact details. Associated with this is a log of all wearable tracking device locations, together with a time and date on which the location was recorded, and any other actions associated with the wearable tracking device, such as records of generated alerts, notifications or the like.

At step 320, the processing system 220 can optionally generate a notification, for example alerting users of the client devices 230 as to the wearable tracking device location. This might be required for example if the wearable tracking device and hence wearer have left a predetermined permitted area or region, for example if they have left their home.

It will therefore be appreciated that this location tracking process is substantially similar to that described in WO 2011/035390 and this will not therefore be described in further detail.

One issue associated with such tracking systems is the ability for individuals to remove the tracking system. In many cases, this is performed inadvertently, for example, because the user finds the wearable tracking device uncomfortable they simply remove it, for example when resting or sleeping, forgetting to replace this prior to moving. However, this can also occur intentionally if the user does not wish to be tracked.

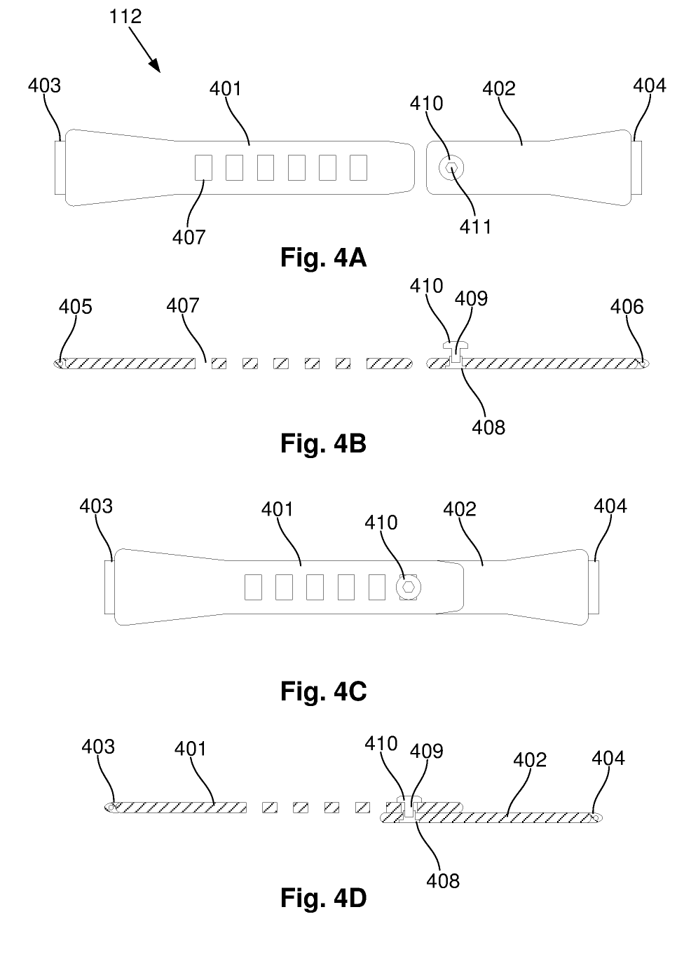

In order to obviate this issue, a locking strap can be provided and an example of this is shown in FIGS. 4A to 4D.

In this example, the wearable tracking device strap 112 includes first and second strap portions 401, 402. The first strap portion 401 is coupled at a first end to the housing 111, for example via a strap fitting 403 including an aperture 405 that receives a locking pin for coupling the wearable tracking device strap to the housing 111. A similar arrangement including a wearable tracking device fitting 404 having an aperture 406 for receiving a corresponding pin can also be provided for the second strap portion 402.

The first strap portion 401 includes a number of apertures 407 spaced along the strap portion 401, whilst the second strap portion 402 includes a mounting 408 provided proximate a second end of the strap portion 402, which in use receives a fastener 409. The fastener 409 is typically inserted through the apertures 407 in the first strap portion 401 and threadingly engaged with the mounting 408, so that the fastener is coupled to the mounting with a head 410 of the fastener 409 abutting against the first strap portion 401, thereby securely fastening the first and second strap portions 401, 402 in position.

To further prevent removal of the wearable tracking device strap, the head is tapered and provides a smooth profile which is difficult for a user to grip, thereby substantially preventing rotation of the fastener 409 unless a tool is used. In one example, this is achieved by having a socket 411 provided in a face of the head 410 so that a key, such as a hex key or the like, can engage the socket, allowing the fastener to be rotated and removed.

It will therefore be appreciated that the wearable tracking device strap can be removed using an appropriate tool, such as a key, but without the key is difficult to remove. From this, it will be appreciated that the intention of the locking system is not to prevent removal of the wearable tracking device but to make removal of the wearable tracking device sufficiently difficult that it cannot be inadvertently or easily removed. Specifically, the locking mechanism is adapted to allow the wearable tracking device to be removed by an individual having both hands useable, but not by an individual having only one hand useable, meaning this substantially prevents the wearable tracking device being removed by the wearer.

Despite this, the wearable tracking device can have a strap that includes a breakable coupling that connects the strap to the body. This can be used to allow the wearable tracking device to be easily removed in an emergency, thereby ensuring the wearable tracking device does not prevent an impediment to assisting the wearer in an emergency.

In one example, in order to further prevent removal of the wearable tracking device, a detection process is performed to automatically determine a worn status of the wearable tracking device, in particular whether the wearable tracking device is or isn't being worn. In this regard, the processor 201 uses signals from a light sensor 208 which is mounted on the underside of the wearable tracking device housing 111 to determine an amount of incident light on the underside of the housing.

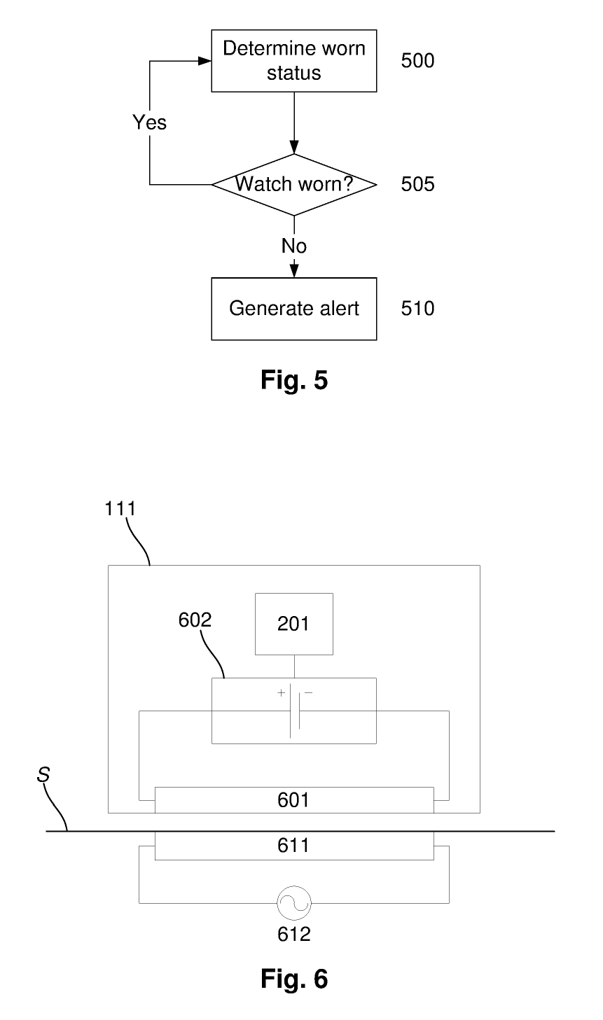

An example of this process will now be described in more detail with reference to FIG. 5.

In this example, at step 500 the processor 201 determines a worn status by examining signals from the light sensor, and at step 505 an assessment is made of whether the wearable tracking device is currently being worn. For example, the amount of light detected can be compared to a threshold, such as an absolute brightness threshold, a relative increase in brightness threshold, and/or a time above an absolute or relative brightness threshold, with removal of the wearable tracking device being determined if the threshold is exceeded. If the wearable tracking device is being worn, the processor returns to step 500 and repeats the process. If not, the processor 201 causes an optional alert to be generated at step 510. The alert may be generated locally, for example by sounding an alarm using the speaker 205, or may alternatively be generated remotely by transferring an indication of wearable tracking device removal to the processing system 220, which in turn can provide notifications to one or more of the client devices 230, alerting users, such as carers or the like, that the wearable tracking device has been removed.

It will be appreciated that the alert may not be required at all times. For example, it may be necessary to remove the wearable tracking device for charging purposes. In this regard, due to the presence of the sensing systems and the need to communicate with the processing system 220, it is typical for a battery life to be limited to a few days, as opposed to say several years for a normal wearable tracking device, and accordingly, in one example, the power supply 211 includes a rechargeable battery.

An example configuration of the power supply will now be described with reference to FIG. 6.

In this example, the power supply 211 includes a coil 601 coupled to a battery 602, via a rectifier or other similar arrangement. In use, the coil 601 forms part of an inductive charging system, and hence cooperates with a corresponding charging coil 611, coupled to an AC power supply 612, which is mounted in a charging unit having a surface S. In use, when the wearable tracking device 110 is positioned on the surface 5, the coils 601, 611 are brought into alignment they are inductively coupled allowing power to be transferred to the battery 602.

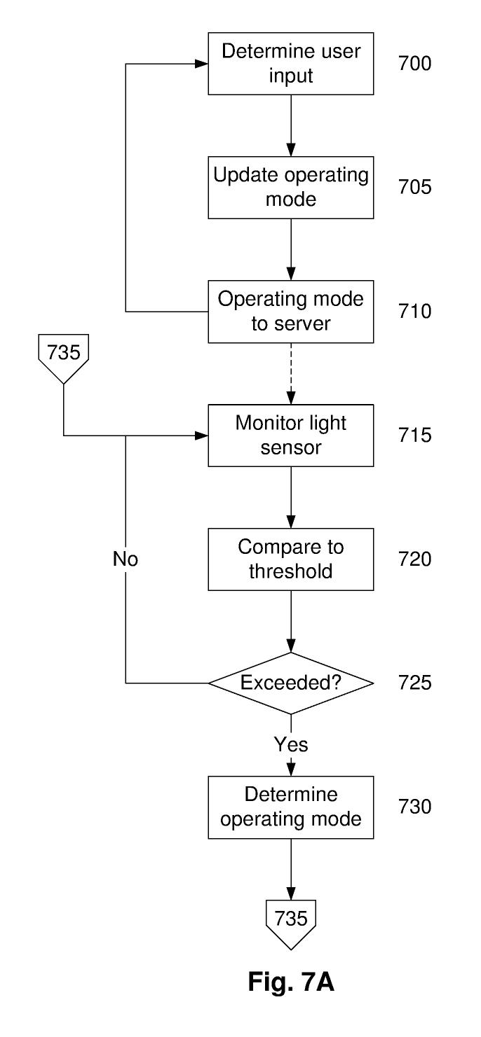

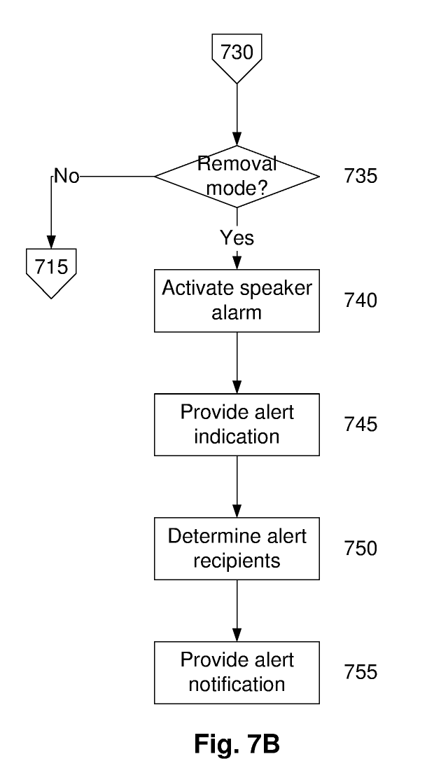

In any event, it will be appreciated from this, that at least during charging, an alert should not be generated if the wearable tracking device is not being worn. Accordingly, in one example, the wearable tracking device can be adapted to determine an operating mode and use this to control whether an alert is generated upon removal of the wearable tracking device. An example of this process will now be described with reference to FIG. 7.

At step 700, user input selecting an operating mode is determined by the processor 201. The user input could be provided in any one of a number of ways, such as by using input buttons 204 to select an appropriate menu option presented on the display 203. Alternatively, the user input could be provided via a client device 230 or the processing system 220, and transmitted to the wearable tracking device 110 wirelessly. In either case, the processor 201 uses the user input to update an operating mode at step 705. An indication of the operating mode can also be transferred to the processing system 220, at step 710, although this is not essential.

This process allows a user to select an operating mode of the wearable tracking device, for example to allow the user to select a charging mode, indicating that the wearable tracking device is to be removed from the individual without the alarm sounding.

It will be appreciated that the ability to alter the operating mode may be restricted to prevent the wearer accessing this themselves. To achieve this, permissions or security may need to be implemented, for example by having a user provide a password or PIN or the like, in order to allow the mode to be altered. Alternatively, the settings to alter the operating mode could be provided in a sub-menu making this difficult for wearers to find, which in many cases would provide sufficient difficulty to prevent this occurring. In this regard, it will be understood that it is not generally necessary to prevent the individual altering the operating mode, but rather to make this sufficiently difficult that this is unlikely to occur in error.

Alterations to the operating mode may be performed at any time with other functions of the wearable tracking device being performed in accordance with the currently selected operating mode, as will be appreciated by a person skilled in the art. Accordingly, the process of monitoring and updating the operating mode as outlined in steps 700 to 710 will typically be performed continually as a background process.

In any event, at step 715 the processor 201 monitors signals from the light sensor 208 and compares the signals to a threshold at step 720. The threshold is used to define an amount of incident ambient light on the underside of the housing 111, which corresponds to the wearable tracking device being removed from the arm of the wearer. If it is determined that the threshold is not exceeded at step 725 the processor returns to step 715, allowing monitoring to be ongoing. Otherwise, at step 730 having determined that the wearable tracking device has been removed, the processor 201 determines the current operating mode of the wearable tracking device. If the wearable tracking device is in a mode in which removal is permitted, such as a charging mode or the like, then no action is taken and the process returns to step 715.

Otherwise, at step 740, the processor 201 activates an audible alert, by causing an alarm sound to be emitted by the speaker 205. This alerts users in the vicinity of the individual that the wearable tracking device has been removed, allowing them to take appropriate action. This is useful for situations in which the wearable tracking device is inadvertently removed and can allow immediate corrective action to be taken.

Additionally, the processor 201 can provide an alert indication to the processing system 220 at step 745. The processing system 220 will determine alert recipients from the wearable tracking device profile at step 750, and then provides alert notifications to the respective recipients at step 755. In this regard, the processing system 220 will typically maintain a list of alert recipients associated with each of a number of types of notification for each wearable tracking device 110, allowing the alert notification to be provided to one or more users, including carers provided on or off site, friends, relatives or the like. The alert notification could be provided by any suitable mechanism, such as SMS, e-mail, phone calls, or the like, as typically indicated in the wearable tracking device profile.

Accordingly, it will be appreciated that the above-described process triggers an alarm in the event that a wearable tracking device is removed, without the wearable tracking device being correctly configured for removal.

In another example, the wearable tracking device can be adapted to allow remote control of a user interface, for example to allow the volume of the speaker 205 or microphone 206 to be controlled remotely, or to allow touch functionality of a touch screen to be activated or deactivated. This is typically achieved by having the remote processing system 220 generate control signals, which are transferred to the wearable tracking device allowing the processor 201 to control the user interface accordingly.

This could be desirable for a number of reasons, such as to allow for two-way communication with the individual, to provide alert notifications to the individual, or the like. For example, if the individual has a fall or requires urgent medical assistance, it may be necessary to communicate with the individual remotely. In this instance, the control signals from the processing system 220 can be used to increase a speaker and microphone volume so that an operator can communicate with the user via the wearable tracking device, using the wearable tracking device as a hands-free phone. This could be performed manually in response to user inputs, such as pressing of a panic button, or automatically, for example based on fall detection, or based on a wearable tracking device location, for example if the wearer moves outside a defined geo-fencing boundary.

Alternatively, this may be required for other reasons, such as to monitor sounds in the vicinity of the wearer, for example to monitor a situation in which an intruder is present in the individual's premises. In this instance, a quiet mode can be used so that the microphone volume is maximised allowing noises within the premises to be monitored, whilst speaker volume is minimised to prevent an intruder being alerted to the fact that this is happening.

Additionally, the ability to provide the tracking device with a touch screen vastly enhances the functionality that can be provided. However, the use of touch screens on devices such as watches can be problematic as it is easy for these to be inadvertently activated, as well as being extremely draining on battery life. Accordingly, the ability to deactivate a touch screen remotely can be used to ensure that user inputs are not provided in error, and to extend the life of the battery.

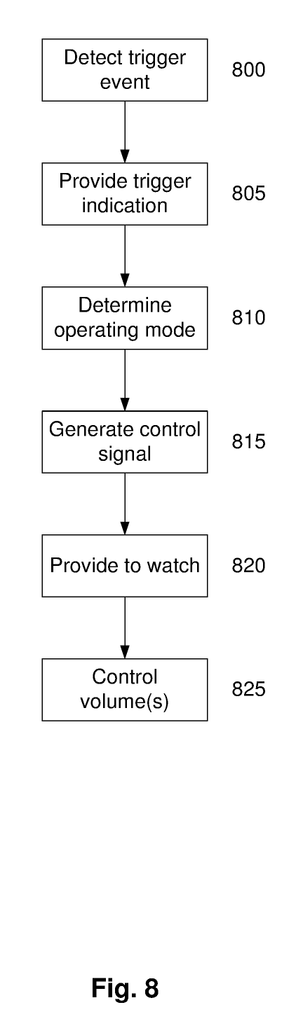

A process for performing this will now be described with reference to FIG. 8.

In this example, at step 800 a trigger event is detected by the processor 201. The nature of the trigger event could vary and could include user input commands supplied via the wearable tracking device, a current wearable tracking device location or input commands provided via a client device, or the like. Additionally, this could include fall detection performed on the basis of signals from movement sensors, as will be described in more detail below.

At step 805, an indication of the trigger is provided to the processing system 220 which determines a corresponding operating mode at step 810. Thus the operating mode could correspond to fall mode, intruder mode, help mode or the like with the processing system 220 operating to determine corresponding volume settings. Control signals are generated at step 815 and provided to the wearable tracking device at step 820 allowing the processor 201 to control the user interface, and in particular the volume of the speaker 205 and/or microphone 206, or the touch functionality of a touch screen, at step 825.

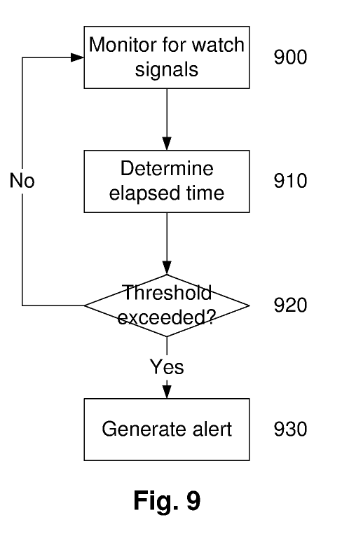

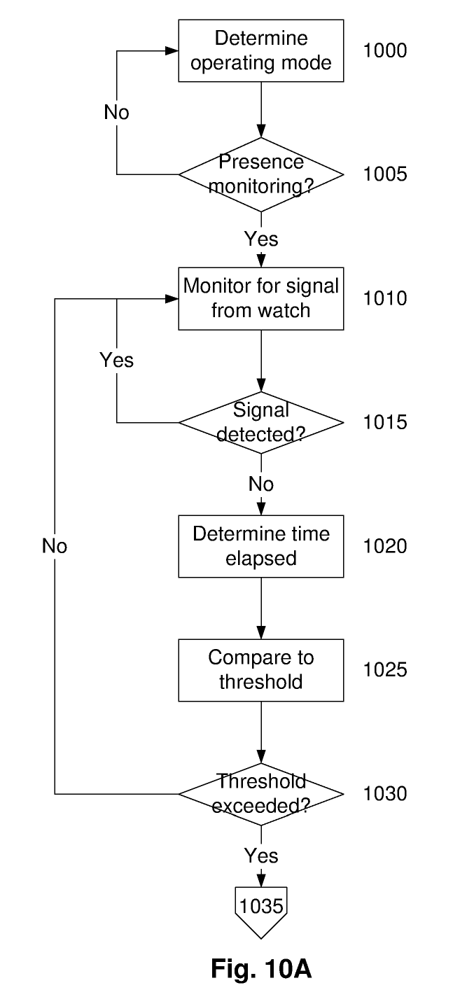

In addition to provide remote user interface control, the wearable tracking device can be adapted to implement a presence detection process, which can detect whether the wearable tracking device is present, or has failed for any reason, such as if the wearable tracking device is broken, the battery discharged, or the like. An example of this will now be described with reference to FIG. 9.

In this example, at step 900 the processing system 220 monitors for wearable tracking device signals. The wearable tracking device signals can be of any appropriate form and could include updates of position information, status updates, responses to poll signals from the processing system, or the like. At step 910 the processing system 220 determines if a predefined time period has elapsed and if not, returns to step 900 to perform ongoing monitoring. Otherwise, if it is determined that the threshold is exceeded at step 920, indicating a defined time period has elapsed, the processing system 220 generates an alert at step 930. This could include displaying an alert to an operator, or providing a notification to one or more users via the client devices 230, allowing appropriate action to be taken, such as attempting to contact the wearer.

Thus, it will be appreciated that this allows the processing system 220 to generate alert notifications in the event that communication with the wearable tracking device has not been received for a defined amount of time.

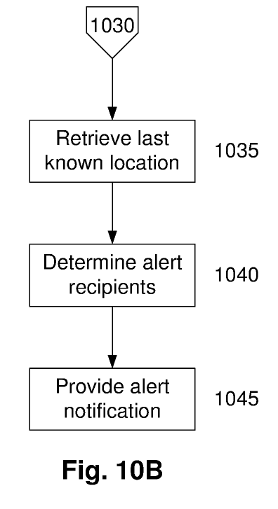

A further example of this will now be described with reference to FIGS. 10A and 10B.

In this example, at step 1000 the processing system 220 determines an operating mode for the wearable tracking device and determines if presence monitoring is activated at step 1005. If not, the process will simply repeat until presence monitoring is activated.

Assuming presence monitoring is activated at step 1010, the processing system 220 monitors for a signal from the wearable tracking device. If a signal is detected at 1015, the process repeats until such time as signals are not detected.

At step 1020 if a signal has not been detected, the time of the last signal is determined with the time elapsed being compared to a threshold at step 1025. If the threshold has not been exceeded monitoring continues as step 1010.

Otherwise, at step 1035 the processing system 220 retrieves a last known location for the wearable tracking device from the database 221, before generating an alert at step 1040, with this being provided to one or more recipients at step 1045.

Thus, it will be appreciated that the above-described process operates to monitor for signals from the wearable tracking device and, in the event that signals are not received, provides an indication of last known location of the wearable tracking device to users allowing them to attempt to locate the wearable tracking device and wearer.

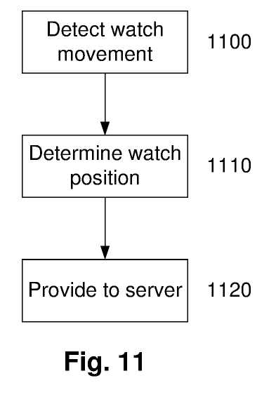

As mentioned above, the wearable tracking device uses a battery and typically requires this to be periodically recharged. To facilitate this, the wearable tracking device can implement battery-saving measures in order to extend battery life. In this regard, position sensing and, in particular, absolute position sensing, such through the use of GPS or other similar sensing techniques, use significant power resources. Accordingly, the system can be adapted to minimise usage of the position sensing systems in order to extend battery life. An example of this process will now be described with reference to FIG. 11.

In particular, the processor 201 operates to detect wearable tracking device movement at step 1100 and then determines a wearable tracking device position in response to wearable tracking device movement at step 1110 providing this information to the processing system 220 at step 1120.

Thus, in this situation, position sensing is only performed following detection of movement, which can be performed using sensors, such as accelerometers, inertial sensors or the like, that only have minimal power requirements. Thus, in this example, wearable tracking device movement is used as a trigger to cause position detection to be performed. As a result position detection is not performed when the wearable tracking device is stationary, thereby significantly reducing power requirements, and extending battery life.

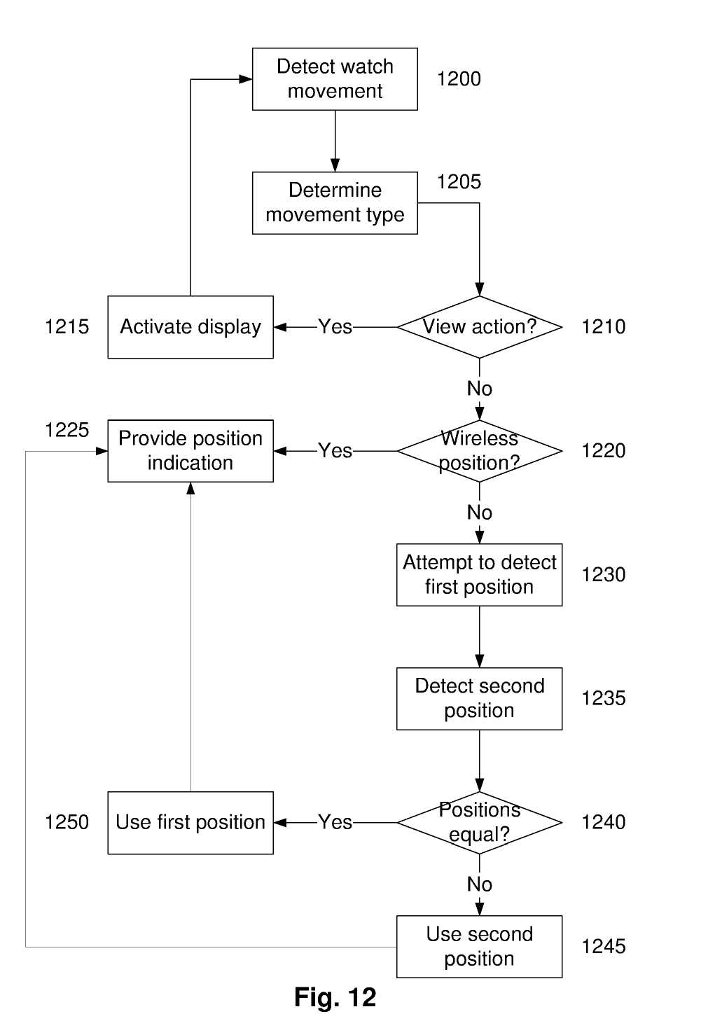

A further example of this process, including additional refinements, will now be described with reference to FIG. 12.

In this example, at step 1200 wearable tracking device movement is detected with the processor 201 operating to determine a movement type at step 1205. In particular, the processor 201 determines if the movement corresponds to a view action at step 1210 and if so, the display 203 is activated at step 1215. The nature of the view action might vary depending on the preferred implementation. For example, if the tracking device is being used as a watch, the view action could correspond to raising of the wearer's arm, identified based on movement and rotation of the tracking device. Alternatively, this could be based on movement to a designated orientation, for example angled to a typical line of sight, or could include a defined pattern of movement such as shaking or tapping, which could be defined during an initial set-up process.

Thus, in this example, if the movement is only raising the arm to view the wearable tracking device display, the wearable tracking device location is not sensed. Additionally, this allows the display to be deactivated when not observed, which in turn assists in further extending battery life.

If it is determined that the movement does not correspond to raising of the arm, then at step 1220 the processor 201 determines if wireless position sensing can be performed. In this regard, wireless position sensing typically corresponds to identifying whether the wearable tracking device is in communication with a known local area communications network, such as a WiFi network, or the like. In this regard, WiFi networks will typically have a limited range and hence identifying if the wearable tracking device is in communication with a WiFi network can allow a location to be identified to a reasonable degree of certainty without requiring operation of an absolute positioning system. If wireless position sensing can be performed, an indication of the determined position is provided to the processing system 220 at step 1225.

Alternatively, at step 1230 the processor 201 operates to attempt to detect a first absolute position with a second absolute position being detected at step 1235. The first position is detected using a first position sensor, such as GPS, which provides a high degree of positional resolution, but which is not available in all circumstances, such as if the wearable tracking device is indoors or the like. In contrast, the second position is determined using an alternative location detection mechanism, which is typically not as spatially accurate, but which is able to function in a wider variety of circumstances, such as detecting a vicinity to a cellular network base station.

At step 1240, the processor 201 determines if the first and second positions are equal and if so, uses the first position providing an indication of the position to the processing system 220 at step 1225. Alternatively, the second position is used on the basis that if the locations are not equal, then the GPS signal is probably incorrect.

Accordingly, this process allows the wearable tracking device location to be determined through a variety of different mechanisms, whilst minimising battery usage, but ensuring accurate location determination is performed.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1. A tracking system for locating an individual, the tracking system comprising a processing system that remotely monitors a wearable tracking device worn by the individual and comprising:
a housing;
a location sensor that senses a location of the wearable tracking device;
a user interface device, comprising at least one of: a display mounted in a face of the housing;
a speaker; and
a microphone;
a wearable tracking device processor communicating with the processing system via a communications network
a memory device electronically coupled to the wearable tracking device processor, the memory device storing instructions which, when executed by the wearable tracking device processor, direct the wearable tracking device processor to:
determine a wearable tracking device location based on signals from the location sensor;
provide an indication of the wearable tracking device location to the processing system configured to at least one of:
store an indication of the wearable tracking device location in a store; and
selectively generate notifications based on the wearable tracking device location;
receive a user interface control indication provided by the processing system; and
control the user interface based on the user interface control indication.

2. The tracking system of claim 1, wherein the processing system generates the control indication based at least in part on at least one of:
instructions received from a client device to allow remote control of the user interface;
a wearable tracking device operating mode; and
a wearable tracking device location.

3. The tracking system of claim 1, in which the instructions, when executed by the wearable tracking device processor, further direct the wearable tracking device processor to at least one of:
adjust a volume of at least one of the microphone and the speaker; and
selectively activate a touch screen function of the display.

4. The tracking system claim 1, wherein the wearable tracking device comprises:
a strap coupled to the housing to retain the wearable tracking device on an arm of the individual; and
a locking system that locks the strap in a securing location to thereby secure the wearable tracking device to an arm of the wearer.

5. The tracking system of claim 4, wherein the wearable tracking device strap comprises a breakable coupling that connects the strap to the body of the wearable tracking device.

6. The tracking system of claim 4, wherein the strap comprises:
a first strap portion coupled to the housing at a first end and having a plurality of apertures along a length of the strap portion; and
a second strap portion coupled to the housing at a second end and having a mounting proximate a second end, wherein in use, a fastener is inserted through one of the apertures and threadingly engages the mounting to thereby secure the first and second strap portions.

7. The tracking system of claim 6, wherein the fastener comprises a head having a tapered profile and a socket configured to receive a key enabling rotation of the fastener thereby for threadingly engaging the mounting.

8. The tracking system of claim 1, wherein the processing system is further configured to at least one of:
store an indication of the wearable tracking device location in a store; and
selectively generate notifications based on the wearable tracking device location, wherein the processing system:
monitors signals from the wearable tracking device;
determines an elapsed time from a last received signal;
compares the elapsed time to a threshold; and
selectively generates an alert depending on the results of the comparison.

9. The tracking system of claim 8, wherein the processing system is further configured to determine the threshold at least in part based on:
a wearable tracking device operating mode; and
a wearable tracking device location.

10. The tracking system of claim 9, wherein the processing system determine the wearable tracking device operating mode based on at least one of:
input commands received via an input provided on the wearable tracking device; and
a wearable tracking device location.

11. The tracking system of claim 8, wherein the processing system is further configured to:
Determine a last known wearable tracking device location from the wearable tracking device location stored in the store; and
generate the alert in accordance with the last known wearable tracking device location.

12. The tracking system of claim 1, wherein the wearable tracking device further comprises a movement sensor that senses movement of the wearable tracking device and wherein the processor instructions, when executed by the wearable tracking device processor, further direct the wearable tracking device processor to:
determine if the movement corresponds to a view raise action using signals from the movement sensor; and,
at least one of:
activate the display in response to a positive determination; and
selectively determine a wearable tracking device location in response to a negative determination.

13. The tracking system of claim 1, wherein the wearable tracking device further comprises a communications system that communicates with communications networks and wherein the instructions, when executed by the wearable tracking device processor, further direct the wearable tracking device processor to determine the location using a local proximity to a communications network.

14. The tracking system of claim 1, wherein the wearable tracking device further comprises an absolute location sensor and wherein the instructions, when executed by the wearable tracking device processor, further direct the wearable tracking device processor to determine the location using the absolute location sensor.

15. The tracking system of claim 14, wherein the wearable tracking device further comprises:
a first location sensor; and,
a second location sensor, and wherein the instructions, when executed by the wearable tracking device processor, further direct the wearable tracking device processor to:
determine first and second locations using signals from the first and second location sensors;
compare the first and second locations; and
determine the wearable tracking device location in accordance with the results of the comparison.

16. The tracking system of claim 1, wherein the instructions, when executed by the wearable tracking device processor, further direct the wearable tracking device processor to determine the wearable tracking device location using a last known wearable tracking device location and movement of the wearable tracking device determined using signals from a movement sensor.

17. The tracking system of claim 1, wherein the wearable tracking device further comprises a fall sensor, the fall sensor being separate to the movement sensor.

18. A tracking system for locating an individual, the tracking system comprising a processing system that remotely monitors a wearable tracking device worn by the individual, wherein the wearable tracking device comprises:
a housing;
a strap coupled to the housing to retain the wearable tracking device on an arm of the individual;
a locking system that locks the strap in a securing location to thereby secure the wearable tracking device to an arm of the wearer;
a display mounted in a face of the housing;
a speaker;
a microphone;
a location sensor that senses a location of the wearable tracking device; and
a wearable tracking device processor that communicates with the processing system via a communications network;
a memory device electronically coupled to the wearable tracking device processor, the memory device storing instructions which, when executed by the wearable tracking device processor, direct the wearable tracking device processor to:
determine a wearable tracking device location based on signals from the location sensor; and
provide an indication of the wearable tracking device location to the processing system, the processing system being adapted to at least one of:
store an indication of the wearable tracking device location in a store; and
selectively generate notifications based on the wearable tracking device location.

19. A tracking system for locating an individual, the tracking system comprising a processing system that remotely monitors a wearable tracking device worn by the individual, wherein the wearable tracking device comprises:
a housing;
a display mounted in a face of the housing;
a location sensor that senses a location of the wearable tracking device;
a wearable tracking device processor that communicates with the processing system via a communications network;
a memory device electronically coupled to the wearable tracking device processor, the memory device storing instructions which, when executed by the wearable tracking device processor, direct the wearable tracking device processor to:
determine a wearable tracking device location in accordance with signals from the location sensor;
provide an indication of the wearable tracking device location to the processing system, the processing system being adapted to at least one of:
store an indication of the wearable tracking device location in a store; and
selectively generate notifications based on the wearable tracking device location and wherein the processing system:
monitors signals from the wearable tracking device;
determines an elapsed time from a last received signal;
compares the elapsed time to a threshold; and
selectively generates an alert based on the results of the comparison.

20. The tracking system of claim 1, wherein the instructions, when executed by the wearable tracking device processor, further direct the wearable tracking device processor:
detect movement of the wearable tracking device based signals from the movement sensor;
determine whether the movement corresponds to a view raise action using signals from the movement sensor; and
at least one of:
activate the display in response to a positive determination; and
selectively determine a wearable tracking device location in response to a negative determination.
